(19) United States
(12) Patent Application Publication
(10) Pub. No.: US 2014/0331114 A1
(43) Pub. Date: Nov. 6, 2014

(54) METHODS AND APPARATUSES FOR OBTAINING AND SHARING PARTIAL CONTENT OF A WEBPAGE

(71) Applicant: CANON KABUSHIKI KAISHA, Tokyo (JP)

(72) Inventors: Weizheng Shen, Beijing (CN); Xinwu Chen, Toronto (CA); Kai Li, Beijing (CN); Zengwei Liu, Beijing (CN)

(73) Assignee: CANON KABUSHIKI KAISHA, Tokyo (JP)

(21) Appl. No.: 14/267,803

(22) Filed: May 1, 2014

(30) Foreign Application Priority Data
May 6, 2013 (CN) 201310161701.9

(51) Int. Cl. G06F 17/22

(52) U.S. Cl. CPC G06F 17/2235; G06F 17/2247
USPC 715/205

(57) ABSTRACT

A method and apparatus for obtaining partial content of a webpage and a method and apparatus for sharing partial content of a webpage. An image of an area on the webpage selected by a user is captured. Linkable elements existing in the area and positions of respective linkable elements in the area are acquired. A HTML fragment is generated based on the image, the linkable elements and their positions in the area as the obtained partial content of the webpage. By virtue of the method and apparatus, Only interested partial content of the webpage can be shared by sharers, and receivers can not only view the partial content of the webpage exactly same with what the sharers view, but also access hyperlinks on this partial content of the webpage directly in a web browser.

### CROSS REFERENCE

The current application claims the benefit of priority from Chinese Patent Application No. 2013/10161701.9 filed on May 6, 2013, which is hereby incorporated by reference in its entirety.

### BACKGROUND OF THE INVENTION

1. Field of the Invention

The present invention relates to a method and apparatus for obtaining partial content of a webpage and a method and apparatus for sharing partial content of a webpage.

2. Description of the Related Art

Traditionally, when a user wants to share a certain part of a webpage that he/she is watching with his/her friends, the user would generally adopt the following two ways:

1) using “screen print” to take a snapshot of the screen; and

2) using “clipboard”.

In the first way, the user can take the snapshot by using “screen print”, so as to get an image of a specified area on the screen which he/she is watching. Then the user can send the image to his/her friend through communication software. Taking the snapshot of the screen display is the easiest and most convenient way to extract the interested partial content of the webpage. With this way, the user can quickly and conveniently share what he/she is watching.

In the second way, the user can select a specified partial content of the webpage from the screen which he/she is watching, and copy it onto the clipboard. When the user wants to share this partial content of the webpage with other user, he/she can paste this partial content onto the communication software, and then send it to the target user. “Copy & Paste” is a typical traditional way for extracting the partial content of the webpage, so that it can be reused.

Although these above methods enable the user to extract the interested partial content in the webpage and then share it with friends, there are many obvious problems existed in these methods.

As to the first way of using “screen print”, the main problem is that, only the displaying information is shared, but the embedded information (for example, hyperlinks etc.) behind the displaying information is missed (for example, hyperlinks are unavailable to the receiver).

As to the second way of using “clipboard”, the main problem is that, the user cannot select web content elements (like an image) partly, for example, the user cannot select only a part of an image; the webpage content cannot be shared directly, and need to be rearranged before sharing; and the shared view which the receiver sees is usually different from what the ‘sender’ watched.

In view of the above, in order to obtain the interested partial content in the webpage and share this partial content among various users, there is a need for such a method which enables:

to extract the specific partial content of the webpage only (including part content elements like image, text, etc.);

to share the same view of the specific partial content of the webpage exactly without need extra operations; and

that not only the views are same to the sender and the receiver, but also those important information (like hyperlinks) embodied in this partial content of the webpage are still available to the receiver.

Thereby, some technologies have been proposed recently. U.S. patent application publication US2012/0010995A1 has disclosed a method for capturing and sharing webpage content. This method creates metadata that describes the location of the webpage content within a selected area of the rendered webpage, and renders the webpage content corresponding to the selected area by sending a message with a link navigating to a widget or highlighted page. FIG. 1 illustrates the main work flow of this method.

Although this method could resolve the several problems of traditional methods, it still has following problems:

receiving user needs to reload the whole shared webpage:
if receiving user operate the shared web content, he/she needs to click the link configured to render the web content. It requires the user to reload the whole shared webpage;
but, if the shared webpage is security-protected, like pages in social network website, etc., it fails to be loaded due to security issues;
even though this prior art document provides a method of “Storing the webpage” in the situation of “security-protected”, it still has the problem to reload the stored “security-protected” webpage;

the rendered view could be rendered differently on devices with different resolutions:
even if this method records the metadata describing the location of the selected area, but on some lower or higher resolution devices, the shared webpage needs to be re-rendered. Then the elements corresponding to the metadata may be different between the captured devices and the receiving devices;

in addition, this prior art method requires utilizing a special-purpose server through which this method processes the shared webpage so as to display merely partial content of the webpage.

### SUMMARY OF THE INVENTION

Therefore, in view of the above recitations in Description of the Related Art, there is a need for methods and apparatuses for obtaining and sharing partial content of a webpage, which enables:

only the selected area is shared, but other content on this webpage should not be included;

only the shared partial content of the webpage needs to be reloaded; and

The shared partial content of the webpage is rendered on the receiver's browser exactly same with on the sharer's browser, and the hyperlinks embodied in this selected area can be accessed by the receiver, irrespective of the receiving device or the browser used by the receiver.

According to one aspect of the present invention, in order to solve the above technical problem, the present invention provides a method for obtaining partial content of a webpage, comprising: capturing step of capturing an image of an area on the webpage selected by a user; acquiring step of acquiring linkable elements existing in the area and positions of respective linkable elements in the area; and generating step of generating a HTML fragment, based on the image, the linkable elements and their positions in the area, as the obtained partial content of the webpage.

According to another aspect of the present invention, in order to solve the above technical problem, the present invention provides a method for sharing partial content of a webpage, comprising: selecting step of enabling a user to select an interested area in the webpage; obtaining step of obtaining webpage content corresponding to the selected area by using the above-described method for obtaining partial content of the webpage; and sharing step of sharing the HTML fragment which is the obtained partial content of the webpage.

According to yet another aspect of the present invention, the present invention provides an apparatus for obtaining partial content of a webpage, comprising: capturing unit configured to capture an image of an area on the webpage selected by a user; acquiring unit configured to acquire linkable elements existing in the area and positions of respective linkable elements in the area; and generating unit configured to generate a HTML fragment, based on the image, the linkable elements and their positions in the area, as the obtained partial content of the webpage.

According to still yet another aspect of the present invention, the present invention provides an apparatus for sharing partial content of a webpage, comprising: selecting unit configured to enable a user to select an interested area in the webpage; the above-described apparatus for obtaining partial content of the webpage, configured to obtain webpage content corresponding to the selected area; and sharing unit configured to share the HTML fragment which is the obtained partial content of the webpage.

According to further aspect of the present invention, the present invention provides a method for adding a favorite item in a web browser, comprising: obtaining step of obtaining partial content of a webpage being browsed by the user by using the above-described method for obtaining partial content of the webpage; creating step of creating a favorite item for the webpage; and binding step of binding the generated HTML fragment with the created favorite item.

As described above, the present invention provides methods and apparatuses for partly obtaining webpage content and sharing it among different users. The selected and shared area has no any limitation and completely equals to the selection area that a user choose. With the methods and apparatuses of the present invention, sharers can share interested partial content of the webpage only, and receivers can not only view the partial content of the webpage, exactly same with what the sharers view, but also access hyperlinks on this partial content of the webpage directly in a web browser.

Further, as compared with the prior art methods discussed in the above Description of the Related Art, the present invention can bring the following advantageous effects:

Comparing with the “screen print” method, the present invention enables users to share more information (e.g., hyperlinks) without more user operations;

Comparing with the “clipboard” method, the present invention needs less user operations (i.e., without need to re-arrange the shared content), enables the sharer to share a part of the webpage content element (for example, a part of an image, a part of text, etc.), and enables the sharer and the receiver to watch the shared partial content in exactly same view;

Comparing with the method proposed in the above U.S. patent application, the present invention enables to share only the interested partial content (even a certain block of text paragraph, a part of image, etc.) and to ensure the receiver to get the same view of this partial content as the sharer, and enables the receiver to only need reload the shared partial content, without need reloading the whole original webpage. Further, the method and apparatus of the present invention can be implemented without utilizing the special-purpose server.

Further, with the above method for adding the favorite item in the web browser, the waiting time in downloading and rendering the whole webpage via ‘Favorites’ of web browser can be reduced, and the time for user to look for actual interested content in re-accessing a webpage can be reduced.

Further characteristic features and advantages of the present invention will be apparent from the following description with reference to the drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 shows an example of a method for capturing and sharing webpage content in the prior art.

FIG. 2 is a block diagram showing a hardware configuration of a computer system which can implement the embodiments of the present invention.

FIG. 3 is a flowchart showing a method for obtaining partial content of a webpage according to an exemplary embodiment of the present invention.

FIG. 4 is a block diagram showing an apparatus for obtaining partial content of a webpage according to an exemplary embodiment of the present invention.

FIG. 5 is a flowchart showing a method for sharing partial content of a webpage according to an exemplary embodiment of the present invention.

FIG. 6 is a block diagram showing an apparatus for sharing partial content of a webpage according to an exemplary embodiment of the present invention.

FIG. 7 shows an exemplary procedure of a method for sharing partial content of a webpage according to an embodiment of the present invention.

FIG. 8 is a flowchart showing a method for adding a favorite item in a web browser according to an exemplary embodiment of the present invention.

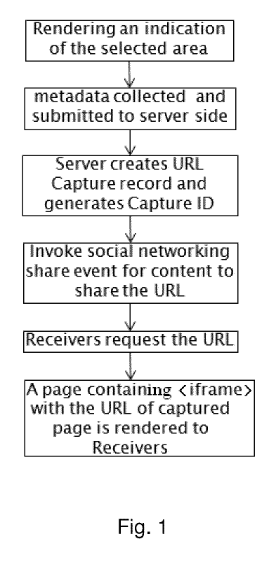

### DESCRIPTION OF THE EMBODIMENTS

The preferred embodiments of the present invention will be described in detail below with reference to the drawings. Details and functions which are not necessary for the present invention are omitted so as not to confuse the understanding of the present invention.

Please note that similar reference numerals and letters refer to similar items in the figures, and thus once an item is defined in one figure, it need not be discussed for following figures.

In the present disclosure, the terms “first”, “second” and the like are only used to discriminate between elements or steps, but are not intended to indicate a temporal order, a preference or an importance.

(Hardware Configuration of a Computer System)

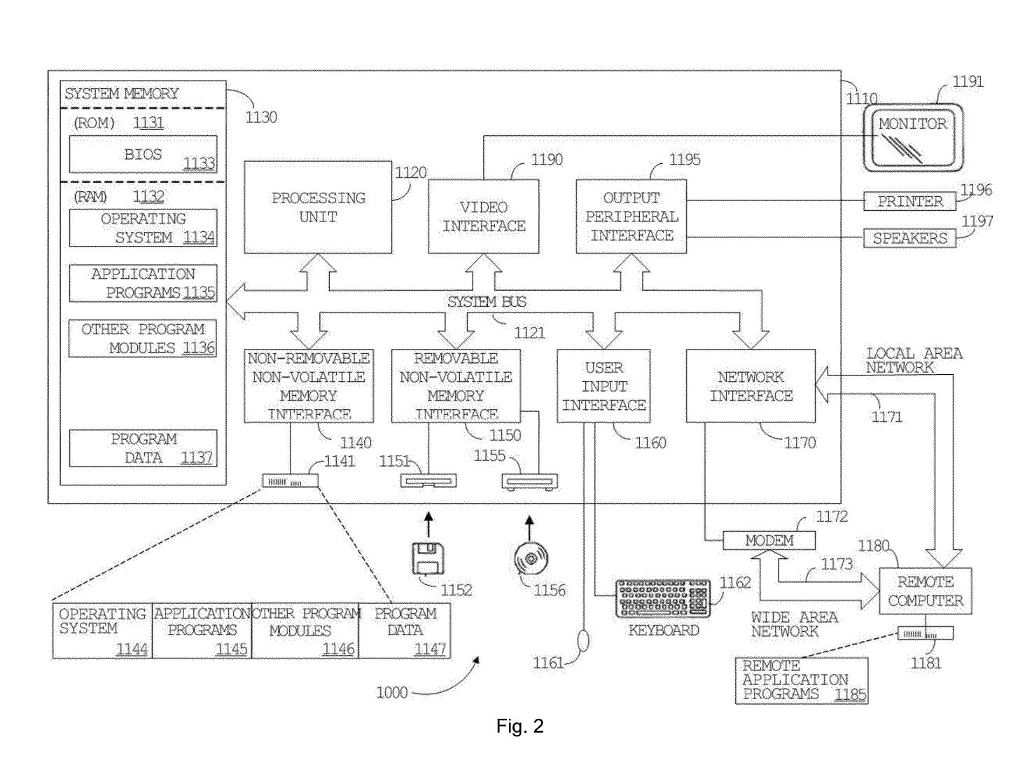

FIG. 2 is a block diagram showing a hardware configuration of a computer system 1000 which can implement the embodiments of the present invention.

As shown in FIG. 2, the computer system comprises a computer 1110. The computer 1110 comprises a processing unit 1120, a system memory 1130, non-removable non-volatile memory interface 1140, removable non-volatile memory interface 1150, user input interface 1160, network interface 1170, video interface 1190 and output peripheral interface 1195, which are connected via a system bus 1121.

The system memory 1130 comprises ROM (read-only memory) 1131 and RAM (random access memory) 1132. A BIOS (basic input output system) 1133 resides in the ROM 1131. An operating system 1134, application programs 1135, other program modules 1136 and some program data 1137 reside in the RAM 1132.

A non-removable non-volatile memory 1141, such as a hard disk, is connected to the non-removable non-volatile memory interface 1140. The non-removable non-volatile memory 1141 can store an operating system 1144, application programs 1145, other program modules 1146 and some program data 1147, for example.

Removable non-volatile memories, such as a floppy drive 1151 and a CD-ROM drive 1155, are connected to the removable non-volatile memory interface 1150. For example, a floppy disk 1152 can be inserted into the floppy drive 1151, and a CD (compact disk) 1156 can be inserted into the CD-ROM drive 1155.

Input devices, such a microphone 1161 and a keyboard 1162, are connected to the user input interface 1160.

The computer 1110 can be connected to a remote computer 1180 by the network interface 1170. For example, the network interface 1170 can be connected to the remote computer 1180 via a local area network 1171. Alternatively, the network interface 1170 can be connected to a modem (modulator-demodulator) 1172, and the modem 1172 is connected to the remote computer 1180 via a wide area network 1173.

The remote computer 1180 may comprise a memory 1181, such as a hard disk, which stores remote application programs 1185.

The video interface 1190 is connected to a monitor 1191.

The output peripheral interface 1195 is connected to a printer 1196 and speakers 1197.

The computer system shown in FIG. 2 is merely illustrative and is in noway intended to limit the invention, its application, or uses.

The computer system shown in FIG. 2 may be implemented to any of the embodiments, either as a stand-alone computer, or as a processing system in an apparatus, possibly with one or more unnecessary components removed or with one or more additional components added.

(Method and Apparatus for Obtaining Partial Content of a Webpage)

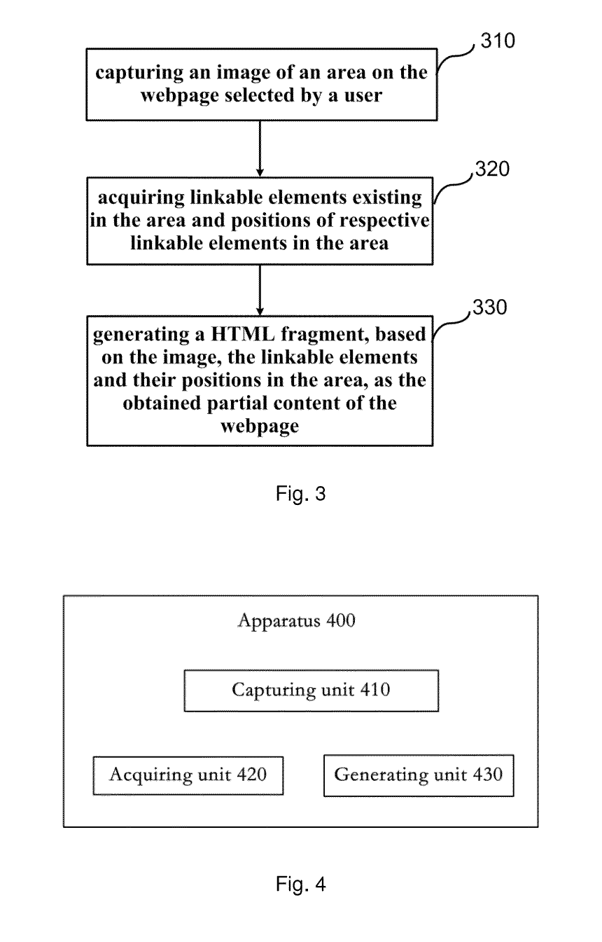

FIG. 3 is a flowchart showing a method for obtaining partial content of a webpage according to an exemplary embodiment of the present invention.

As shown in FIG. 3, in capturing step 310, an image of an area on the webpage selected by a user is captured. In the case that the method according to the present invention is embodied in a web browser, optionally, an option (for example, “Enable Block Selection” Check Box) can be provided in the browser, to enable/disable the method for obtaining the partial content of the webpage according to the present invention. In this case, only when the method of the present invention is enabled, the capturing step 310 is performed. With providing this option, the user can be allowed to freely choose the method of the present invention or the traditional methods to adaptively obtain the webpage content.

In one implementation, the image of the area on the webpage selected by the user may be captured by the following operations: when the user drags a device pointer, capturing a location point of the device pointer at a time when starting the dragging and a location point of the device pointer at a time when ending the dragging; determining the area selected by the user, based on the location point of the device pointer at a time when starting the dragging and the location point of the device pointer at a time when ending the dragging; and getting pixel data of the area selected by the user and compressing the pixel data to an image format so as to form the image.

In another implementation, the image of the area on the webpage selected by the user may be captured by the following operations: catching a motion and identifying an area covered by the motion when the user drags a device pointer; catching the point of the device pointer when the user releases the device pointer, and determining the last recorded area as the area selected by the user; and getting pixel data of the area selected by the user and compressing the pixel data to an image format so as to form the image. With this way, the area selected currently by the user may be displayed on the webpage in a real time, so as to facilitate the user to determine desired selected area.

The above image format is not particularly limited, and may be, e.g., png, jpeg, etc.

The above way is for the apparatus provided with the device pointer, however, as to an apparatus without a device pointer, e.g., an apparatus with touch screen, the user can utilize the finger touch motion and the like to select the area and capture the image of the area on the webpage selected by the user in a similar way.

In acquiring step 320, linkable elements existing in the area and positions of respective linkable elements in the area are acquired.

In one implementation, the linkable elements existing in the area may be acquired by steps of: analyzing contents of the webpage; and recording the linkable elements covered or partly covered by said area. Further, examples of the steps of analyzing and recording comprise: getting all elements covered or partly covered by the area; traversing all the elements; and finding out and recording all of the linkable elements.

The positions of respective linkable elements in the area may be acquired by steps of: getting positions of the linkable elements and the area respectively on the webpage; and calculating the positions of respective linkable elements in the area, based on the positions of the linkable elements and the area respectively on the webpage.

Preferably, for each of the linkable elements, the above step of calculating may comprise: getting regions for the rendered linkable elements; and calculating positions of the regions for the respective rendered linkable elements in the area, with the top left of the area selected by the user as origin of the coordinate. In some cases, one linkable element is rendered as more than one region, for example, the linkable element is rendered as multiple lines. In such cases, at first, each rendered region of the linkable element and its position in the area selected by the user are acquired respectively, and as will be described below, each rendered region of the linkable element will be separately described in the generated HTML fragment.

It is apparent to those skilled in the art that, the acquiring step 320 is not limited to the above-described implementations, and can be implemented by utilizing various well-known technologies.

Next, in the generating step 330, a HTML fragment is generated based on the image, the linkable elements and their positions in the area, as the obtained partial content of the webpage.

In one implementation, the generating step may be implemented by steps of: creating an <img> element with the image; and creating a <map> element, to append information corresponding to the linkable elements on the image.

Preferably, the step of creating the <map> element may comprise: creating an empty <map> element; generating a <area> element by using each linkable element and the position of the corresponding linkable element in the area; and adding the <area> element into the <map> element.

In addition, preferably, the step of generating the <area> element may comprise: creating a <area> element, wherein the <area> element includes at least ‘href’ attribute and ‘coords’ attribute; assigning the ‘href’ attribute of the <area> element with the source URI of the linkable element; and specifying the position of the linkable element in the area as the ‘coords’ attribute of the <area> element. In some cases, the <area> element may include other attributes, in addition to the ‘href’ attribute and ‘coords’ attribute, for example, ‘alt/title’ attribute for indicating to the user the text information of the corresponding linkable element, ‘target’ attribute for specifying where to open the target URL specified by the ‘href’ attribute, and the like.

As described above, in some cases, one linkable element is rendered as more than one region. In this case, preferably, for each rendered region of one linkable element, a <area> element is generated in a way similar as the above.

One example of the generated HTML fragment is shown as follow:

```
<img src=“data:image/png;base64, xxx” style=“width: xxx;height: xxx”
usemap=“#clipMapping” />
  <map name=“clipMapping”>
  <area shap=“rect” coords=“x0, y0, x00, y00” href=“http://xxxx”
title=‘Buy’ alt=‘Hyper Link1’>
  <area shap=“rect” coords=“x1, y1, x10, y10” href=“http://xxxx”
title=‘Buy’ alt=‘Hyper Link2’>
  <area shap=“rect” coords=“x2, y2, x20, y20” href=“http://xxxx”
title=‘Buy’ alt=‘Hyper Link3’>
</map>
```

It will be understood by those skilled in the art that, the above-described method for generating the HTML fragment and the example thereof are merely illustrative but not limiting.

FIG. 4 is a block diagram showing an apparatus for obtaining partial content of a webpage according to an exemplary embodiment of the present invention.

As shown in FIG. 4, the apparatus 400 for obtaining partial content of a webpage according to the exemplary embodiment of the present invention comprises: a capturing unit 410, an acquiring unit 420, and a generating unit 430.

More specifically, the capturing unit 410 is configured to capture an image of an area on the webpage selected by a user.

The acquiring unit 420 is configured to acquire linkable elements existing in the area and positions of respective linkable elements in the area.

The generating unit 430 is configured to generate a HTML fragment, based on the image, the linkable elements and their positions in the area, as the obtained partial content of the webpage.

The respective units in the apparatus 400 can be configured to perform the respective steps shown in the flowchart in FIG. 3.

With the above-described method and apparatus, partial content selected by the user in a webpage may be obtained as a HTML fragment, so as to allow other people to get exactly same view as the part selected by the user when viewing the HTML fragment, and to easily access the linkable elements embedded in this partial content. The obtaining method and apparatus with the above-described characteristics can be applied to various applications, e.g., an application for sharing partial content of a webpage. A method and apparatus for sharing partial content of a webpage to which the obtaining method and apparatus according to the present invention is applied will be described in detail hereinafter.

(Method and Apparatus for Sharing Partial Content of a Webpage)

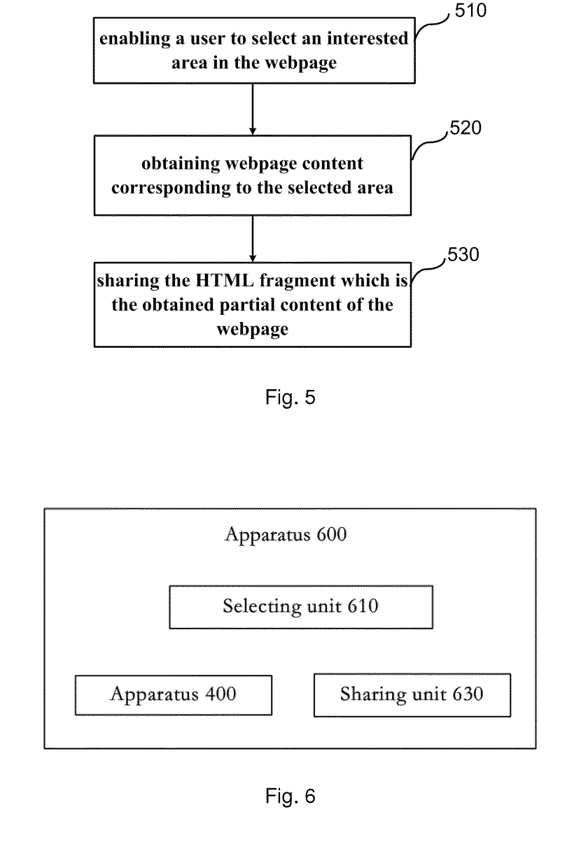

FIG. 5 is a flowchart showing a method for sharing partial content of a webpage according to an exemplary embodiment of the present invention.

As shown in FIG. 5, in selecting step 510, a user is enabled to select an interested area in the webpage. The user may select the interested area by means of a device pointer or by motions of fingers touching on a device with a touch screen.

In obtaining step 520, webpage content corresponding to the selected area is obtained by using the above-described method for obtaining the partial content of the webpage. This webpage content is represented by the generated HTML fragment.

In sharing step 530, the HTML fragment, which is the obtained partial content of the webpage, is shared. In one implementation, the HTML fragment, which is the obtained partial content of the webpage, may be sent to a receiver through a communication tool. The communication tool may be: for example, IM Clients, Emails, various social networking services and the like. After the receiver who is the sharing object has received this HTML fragment, this receiver can browse this HTML fragment, thereby to browse the shared partial content in a same view as what the sharer saw and wished to share. The receiver may render the shared partial content of the webpage in a web browser.

FIG. 6 is a block diagram showing an apparatus for sharing partial content of a webpage according to an exemplary embodiment of the present invention.

As shown in FIG. 6, the apparatus 600 for sharing partial content of a webpage according to the exemplary embodiment of the present invention comprises: a selecting unit 610, the above-described apparatus 400 for obtaining partial content of the webpage, and a sharing unit 630.

More specifically, the selecting unit 610 is configured to enable a user to select an interested area in the webpage.

The above-described apparatus 400 for obtaining partial content of the webpage is configured to obtain webpage content corresponding to the selected area.

The sharing unit 630 is configured to share the HTML fragment which is the obtained partial content of the webpage.

The respective units in the apparatus 600 can be configured to perform the respective steps shown in the flowchart in FIG. 5.

(Exemplary Procedure of a Method for Sharing Partial Content of a Webpage)

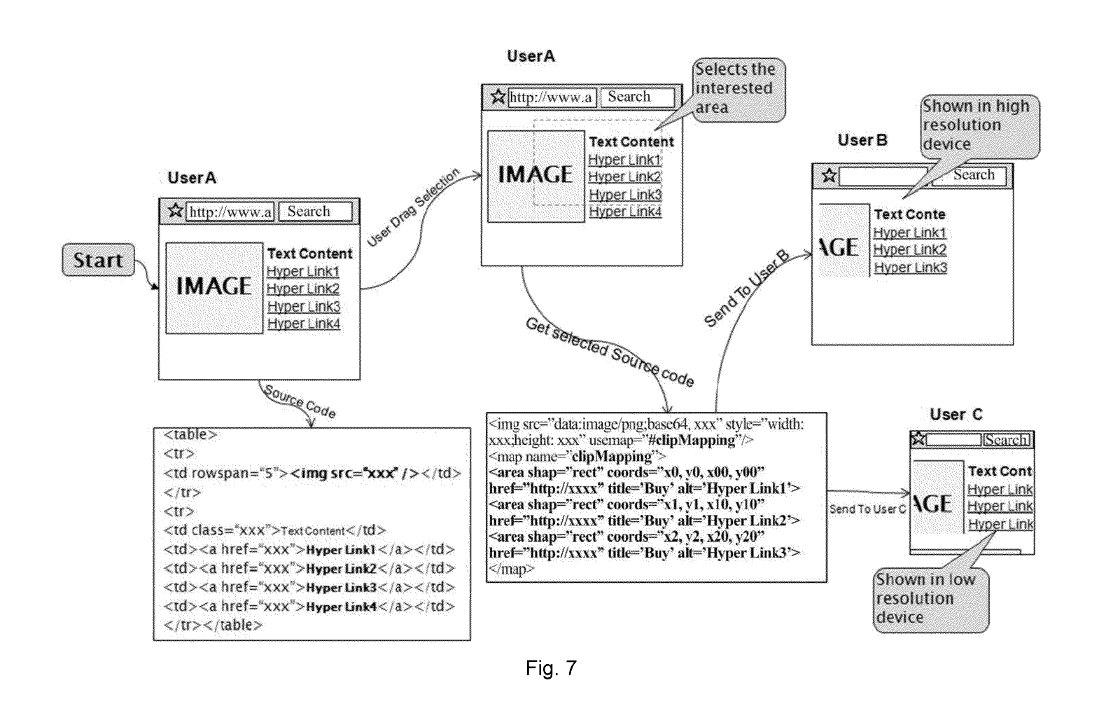

FIG. 7 shows an exemplary procedure of a method for sharing partial content of a webpage according to an embodiment of the present invention. The sharing method according to the present invention and advantageous effects thereof are demonstrated explicitly by means of this example.

As shown in FIG. 7, at first, user A is watching a webpage (“Hyper Link1”, “Hyper Link2”, “Hyper Link3” and “Hyper Link4” in the drawing exemplarily indicate four hyperlinks). When watching this webpage, the user A wishes to share its partial content with other users (e.g., user B and user C). Thus, the user A selects an area which he/she is interested in on the webpage, and then, based on the selection of the user, the method of the present invention obtains webpage content corresponding to the selected area, i.e., a HTML fragment. Next, this HTML fragment is shared with the user B and user C. For example, this HTML fragment is sent to the user B and user C through various communication tools. As shown in FIG. 7, the user B uses a high resolution device, and the user C uses a low resolution device. In addition, it can be seen from the drawing that, the receiving users see exactly same view as the user A, irrespective of the resolution of the device. Further, the hyperlinks included in the shared partial content can also be accessed directly by the user B and user C.

(Usage Examples of Partial Content of Webpage Obtained by the Present Invention)

As described above, in the application of sharing partial content of a webpage, the user can create his/her interested partial content of a webpage as a HTML fragment, and share it with a receiver. The receiver receives the shared HTML fragment, and then browses this shared HTML fragment (information) by using a common web browser engine. Thereby, the receiver can browse the shared partial content in a same view as what the sharer (i.e. the sender) saw and wished to share, and click the hyperlinks within the webpage partial content for visiting relevant information as reference.

Please note that, the obtained webpage partial content can be used not only by the receiver, but also by the sender. For example, the obtained partial content of the webpage can be added to ‘Favorites’ (which are called ‘Bookmarks’ or other terms in some kinds of web browsers) in the web browser, via which the sender can easily re-access his/her interested information in the future. The detailed process will be explained below. Please note that, although the following usage example will be described by discussing ‘Favorites’, the same process also applies to features having a same or similar function as ‘Favorites’ but having different names in other kinds of web browsers, e.g., ‘Bookmarks’.

Currently, when a user thinks interested web content as a part of a webpage may be useful in future, he/she may add this webpage into ‘Favorites’ of the web browser for future's re-accessing. And when the user wants to re-access this webpage again, the conventional process in current major web browsers may comprise the following steps of:

1) Checking the ‘Favorites’ list and selecting one item to re-access the corresponding webpage;

2) Downloading the selected webpage and browsing for interested content.

However, there are several problems in the conventional method as follow:

1) In re-accessing process, the user needs to reload the whole corresponding webpage, which results in a long waiting time in the case of limited low bandwidth;

2) After the whole webpage is reloaded, it would take some time for the user to look for the actual interested content (especially in the case of a huge webpage, it's a time consuming job), which is a kind of ‘waste’ because the user did the same ‘looking for’ in the first time; and the like.

Therefore, the present invention proposes to apply the above method for obtaining partial content of the webpage according to the present invention to improve ‘Favorites’ feature of the web browsers.

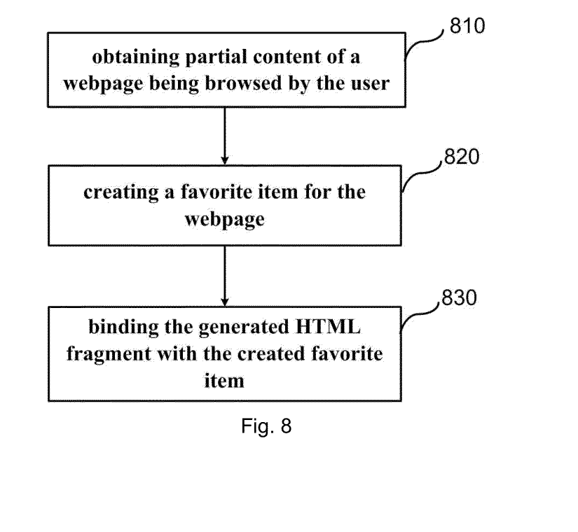

That is to say, the present invention provides a method for adding a favorite item in a web browser, whose example flowchart is shown in FIG. 8. With using such method of the present invention, a more friendly and less time-consuming ‘Favorites’ feature can be implemented in a web browser.

As shown in FIG. 8, in obtaining step 810, partial content of a webpage being browsed by the user is obtained by using the above-described method for obtaining the partial content of the webpage. The partial content of the webpage is represented by the generated HTML fragment.

In creating step 820, a favorite item is created for the webpage. The favorite item can be created by using any available methods.

In binding step 830, the generated HTML fragment is bound with the created favorite item. In one implementation, binding, i.e., associating, the HTML fragment with the favorite item can be achieved by, for example, creating a map table for the favorite item and the HTML fragment. It should be understood that, the binding can be implemented by using any available methods.

As a result, the favorite item bound with the generated HTML fragment is added into the ‘Favorites’ list.

Thereafter, when the user wishes to re-access the interested webpage, the user checks the ‘Favorites’ list and selects its corresponding favorite item. While the favorite item is selected, the HTML fragment bound with the selected favorite item is displayed as, for example, a floating window. That is to say, in some implementations, when the user puts the mouse on a favorite item, its bound HTML fragment, if any, can be displayed, even if the favorite item is not clicked to reload the corresponding webpage. If desired, the user can directly click the hyperlinks contained in the displayed HTML fragment.

In this case, the user can re-access his/her interested partial content of a webpage directly and very fast, without reloading the correlated whole webpage and looking for the interested content throughout the whole webpage. Also, the user can access the hyperlinks in the displayed HTML fragment directly. In the case that the partial content of the webpage displayed in the HTML fragment is not enough for the user, the user can download the whole webpage and browse for interested content.

Therefore, with the above method for adding the favorite item in the web browser, the waiting time in downloading and rendering the whole webpage via ‘Favorites’ of web browser can be reduced, and the time for user to look for actual interested content in re-accessing a webpage can be reduced.

All of the units described above are exemplary and/or preferable modules for implementing the processes described in the present disclosure. These units can be hardware units (such as a FPGA (field programmable gate array), a digital signal processor, an application specific integrated circuit or the like) and/or software modules (such as computer readable program). The units for implementing the various steps are not described exhaustively above. However, where there is a step of performing a certain process, there may be a corresponding functional module or unit (implemented by hardware and/or software) for implementing the same process. Technical solutions by all combinations of steps described and units corresponding to these steps are included in the disclosure of the present application, as long as the technical solutions they constitute are complete and applicable.

Furthermore, the above-described apparatus 400 or 600 constituted of various units can be incorporated into an electronic device such as computer, mobile phone, handheld device or the like, as a functional module, as long as there is a need for obtaining and sharing partial content of a webpage in the electronic device. The electronic device, as a matter of course, has other hardware or software components in addition to this apparatus 400 or 600.

As described above, the methods and apparatuses according to the present invention are applicable to a variety of browsers, as well as to various applications or various devices having a function of obtaining and sharing partial content of a webpage.

It is possible to carry out the method and apparatus of the present invention in many ways. For example, it is possible to carry out the method and apparatus of the present invention through software, hardware, firmware or any combination thereof. The above described order of the steps for the method is only intended to be illustrative, and the steps of the method of the present invention are not limited to the above specifically described order unless otherwise specifically stated. Besides, in some embodiments, the present invention may also be embodied as programs recorded in recording medium, including machine-readable instructions for implementing the method according to the present invention. Thus, the present invention also covers the recording medium which stores the program for implementing the method according to the present invention.

Although some specific embodiments of the present invention have been demonstrated in detail with examples, it should be understood by a person skilled in the art that the above examples are only intended to be illustrative but not to limit the scope of the present invention. It should be understood by a person skilled in the art that the above embodiments can be modified without departing from the scope and spirit of the present invention. The scope of the present invention is defined by the attached claims.

What is claimed is:

1. A method for obtaining partial content of a webpage, comprising:
capturing step of capturing an image of an area on the webpage selected by a user;
acquiring step of acquiring linkable elements existing in the area and positions of respective linkable elements in the area; and
generating step of generating a HTML fragment, based on the image, the linkable elements and their positions in the area, as the obtained partial content of the webpage.

2. The method according to claim 1, wherein the linkable elements existing in the area are acquired by steps of:
analyzing contents of the webpage; and
recording the linkable elements covered or partly covered by said area.

3. The method according to claim 1, wherein the positions of respective linkable elements in the area are acquired by steps of:
getting positions of the linkable elements and the area respectively on the webpage; and
calculating the positions of respective linkable elements in the area, based on the positions of the linkable elements and the area respectively on the webpage.

4. The method according to claim 1, wherein the generating step comprises:
creating an <img> element with the image; and
creating a <map> element, to append information corresponding to the linkable elements on the image.

5. The method according to claim 2, wherein the steps of analyzing and recording comprise:
getting all elements covered or partly covered by the area;
traversing all the elements; and
finding out and recording all of the linkable elements.

6. The method according to claim 3, wherein, for each of the linkable elements, the step of calculating comprises:
getting regions for the rendered linkable elements; and
calculating positions of the regions for the respective rendered linkable elements in the area, with the top left of the area selected by the user as origin of the coordinate.

7. The method according to claim 4, wherein the step of creating the <map> element comprises:
creating an empty <map> element;
generating a <area> element by using each linkable element and the position of the corresponding linkable element in the area; and
adding the <area> element into the <map> element.

8. The method according to claim 7, wherein the step of generating the <area> element comprises:
creating a <area> element, wherein the <area> element includes at least ‘href’ attribute and ‘coords’ attribute;
assigning the ‘href’ attribute of the <area> element with the source URI of the linkable element; and
specifying the position of the linkable element in the area as the ‘coords’ attribute of the <area> element.

9. A method for sharing partial content of a webpage, comprising:
selecting step of enabling a user to select an interested area in the webpage;
obtaining step of obtaining webpage content corresponding to the selected area by using the method according to any one of claim 1; and
sharing step of sharing the HTML fragment which is the obtained partial content of the webpage.

10. The method according to claim 9, wherein the selecting step comprises:
selecting the interested area by dragging on the webpage using a device pointer or fingers.

11. An apparatus for obtaining partial content of a webpage, comprising:
capturing unit configured to capture an image of an area on the webpage selected by a user;
acquiring unit configured to acquire linkable elements existing in the area and positions of respective linkable elements in the area; and
generating unit configured to generate a HTML fragment, based on the image, the linkable elements and their positions in the area, as the obtained partial content of the webpage.

12. The apparatus according to claim 11, wherein the acquiring unit comprises:
analyzing and recording unit configured to analyze contents of the webpage and recording the linkable elements covered or partly covered by said area.

13. The apparatus according to claim 11, wherein the acquiring unit comprises:
positions-getting unit configured to get positions of the linkable elements and the area respectively on the webpage; and
calculating unit configured to calculate the positions of respective linkable elements in the area, based on the positions of the linkable elements and the area respectively on the webpage.

14. The apparatus according to claim 11, wherein the generating unit comprises:
<img>-element-creating unit configured to create an <img> element with the image; and
<map>-element-creating unit configured to create a <map> element, to append information corresponding to the linkable elements on the image.

15. The apparatus according to claim 12, wherein the analyzing and recording unit comprise:
a unit configured to get all elements covered or partly covered by the area;
a unit configured to traverse all the elements; and
a unit configured to find out and record all of the linkable elements.

16. The apparatus according to claim 13, wherein the calculating unit comprises:
a unit configured to, for each of the linkable elements, get regions for the rendered linkable elements; and
a unit configured to calculate positions of the regions for the respective rendered linkable elements in the area, with the top left of the area selected by the user as origin of the coordinate.

17. The apparatus according to claim 14, wherein the <map>-element-creating unit comprises:
empty-<map>-element-creating unit configured to create an empty <map> element;
<area>-element-generating unit configured to generate a <area> element by using each linkable element and the position of the corresponding linkable element in the area; and
adding unit configured to add the <area> element into the <map> element.

18. The apparatus according to claim 17, wherein the <area>-element-generating unit comprises:
<area>-element-creating unit configured to create a <area> element, wherein the <area> element includes at least ‘href’ attribute and ‘coords’ attribute;
‘href’-attribute-assigning unit configured to assign the ‘href’ attribute of the <area> element with the source URI of the linkable element; and
‘coords’-attribute-specifying unit configured to specify the position of the linkable element in the area as the ‘coords’ attribute of the <area> element.

19. An apparatus for sharing partial content of a webpage, comprising:
selecting unit configured to enable a user to select an interested area in the webpage;
the apparatus for obtaining partial content of the webpage according to claim 11, configured to obtain webpage content corresponding to the selected area; and
sharing unit configured to share the HTML fragment which is the obtained partial content of the webpage.

20. The apparatus according to claim 19, wherein the selecting unit comprises:
a unit configured to enable to select the interested area by dragging on the webpage using a device pointer or fingers.
